(19) United States
(12) Patent Application Publication
(10) Pub. No.: US 2005/0004812 A1
(43) Pub. Date: Jan. 6, 2005

(54) Method and apparatus for linking business interests

(75) Inventor: Richard J. Fine, Daphne, AL (US)

Correspondence Address: BAKER & HOSTETLER LLP;Washington Square, Suite 1100, 1050 Connecticut Avenue, N.W., Washington, DC, 20036, US

(73) Assignee: Richard J. Fine

(21) Appl. No.: 10/823,599

(22) Filed: Apr. 14, 2004

Related U.S. Application Data
(60) Provisional application No. 60/484,287, filed on Jul. 3, 2003.

(51) Int. Cl. G06F 17/60

(52) U.S. Cl. 705/1; 705/7

(57) ABSTRACT

Methods and apparatus for linking business interests, which are particularly suited for linking business interests, such as equipment, real estate, technical expertise, product purchasers, material inventories, purchase agreements, intellectual property and investment capital via the vehicle of the Internet for the purpose of forming or growing a business.

### PRIORITY

This application claims priority to the provisional patent application, 60/484,287 entitled METHOD AND APPARATUS FOR LINKING BUSINESS INTERESTS, filed Jul. 3, 2003, the disclosure of which is incorporated herein by reference.

### FIELD OF THE INVENTION

The present invention relates generally to business interests, such as equipment, real estate, technical expertise, product purchasers, material inventories, intellectual property, purchase agreements and investment capital. More particularly, the present invention relates to linking these and other business interests via the vehicle of the Internet for the purpose of forming or growing a business.

### BACKGROUND OF THE INVENTION

In putting together business ventures, or deals, business people try to find other people or companies that have money, experience, equipment or real estate, etc., in order to attempt to bring together the components needed to make a successful venture. In doing so the ways and means that were available to the business person were primarily the use of a ROLODEX, the YELLOW PAGES, word of mouth, cold calling on prospects, and, ultimately, in more recent times, performing searches on the Internet about particular companies to learn what businesses they were in and what capital and equipment they possessed which was available on the companies' web sites. In utilizing all of these methodologies, the business person is often left frustrated with the traditional methodologies.

Bentley Communications Corporation (“Bentley”) operates a web site (www.bentleycompanies.com) which barters and trades over the Internet. Bentley does not link business interests as stated in the present invention in order to create and leverage a variety of businesses.

Other web sites that match customers include www.NVST.com which matches capital with entrepenuers only and www.VFinance.com which acts as a brokerage which matches venture captial with businesses as well

The present invention has the ability to unlock unused or underutilized capital that is otherwise “lying dormant” for lack of a vehicle to bring all of the parties together. This dormant capital may occur due to unsuccessful sales, insufficient time to produce sales, or a lack of knowledge of how to leverage a service or product in the marketplace.

The present invention overcomes the prior art problems by utilizing the Internet. In particular, an approach for linking business interests to one another more easily is highly desirable.

### SUMMARY OF THE INVENTION

The present invention overcomes the need for using conventional means of linking various business interests by utilizing the connectivity of the Internet.

It is therefore a feature of the present invention to provide a method for linking business interests, comprising the steps of: receiving postings of business interests to a provider; providing to a customer access to said postings; and linking said customer to said business interests, wherein said business interests consists of a group including, equipment, real estate, intellectual property, technical expertise, purchase agreements, material inventories, product purchases, and investment capital.

It is another feature of the present invention to provide a Acomputer-readable medium for linking business interests to customers, the computer-readable medium carrying one or more sequences of one or more instructions which, when executed by one or more processors, cause the one or more processors to perform the compute-implemented steps of: receiving postings of business interests to a provider; providing to a customer access to said postings; and linking said customer to said business interests, wherein said business interests consists of a group including, equipment, real estate, intellectual property, technical expertise, purchase agreements, material inventories, product purchases, and investment capital.

It is yet another feature of the present invention to provide an apparatus for linking business interests, comprising: one or more processors; and a memory communicatively coupled to the one or more processors, the memory including one or more sequences of one or more instructions which, when executed by the one or more processors, cause the one or more processors to perform the steps of: receiving postings of business interests to a provider; providing to a customer access to said postings; and linking said customer to said business interests, wherein said business interests consists of a group including, equipment, real estate, intellectual property, technical expertise, purchase agreements, material inventories, product purchases, and investment capital.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purposes of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent construction insofar as they do not depart from the spirit and scope of the present invention.

### BRIEF DESCRIPTION OF THE DRAWINGS

FIG. 1 is a diagram of one preferred embodiment of the present invention showing an approach for linking business interests of customers.

FIG. 2 is a flow diagram depicting an approach for linking business interests to customers or users according to an embodiment of the present invention.

FIG. 3 is a diagram depicting an approach for linking business interests to customers over the Internet according to an embodiment of the present invention.

FIG. 4 is a block diagram of a computer system upon which embodiments of the present invention may be implemented.

### DESCRIPTION OF THE INVENTION

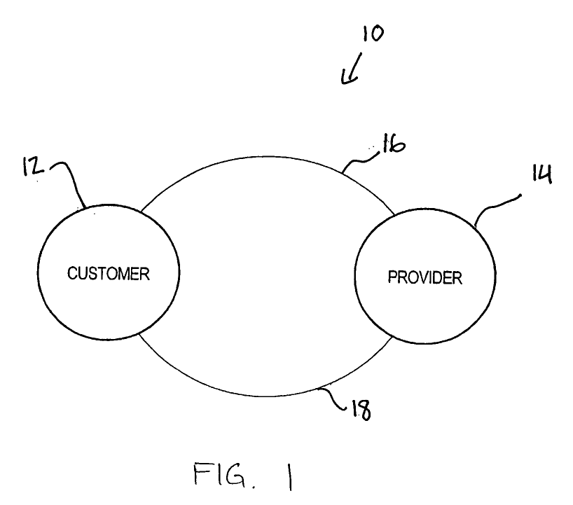

Referring to FIGS. 1-4, a preferred embodiment of the invention provides a vehicle that entrepreneurs/users throughout the world may utilize to bring unused or underused assets to the table as part of a joint venture, or deal. The present invention is a comprehensive web site from which any person that desires to put together a venture or deal, can go to access.

Referring to FIG. 1, a particular user or customer 12 can utilize the present invention to find the resources from a provider 14 that he or she needs to put a business together through a link 16 and delivery channel 18.

For example, the entrepreneur/user may wish to build a metal foundry. The user has decided that he wants to locate his foundry in the State of Alabama and the most important component of this foundry is going to be the real estate. He utilizes the present invention, which is filled with postings of everything that the user needs to complete his project. In this case, the major shopping list for his project is real estate, furnace equipment, chemical and/or mechanical engineering expertise and transport equipment.

The present invention may be filled with postings for all of these different business interests that are required for this joint venture, or deal, or any other joint venture, or deal, for which people and/or companies have posted for a one time annual fee per posting. A person posting a forklift using the present invention may be charged the same cost as a person posting twenty-five acres of highly valuable commercial real estate. In our example the user's primary interest is to locate real estate for his plant where he desires to locate in Alabama and he finds someone in Mobile, Ala. that offers 25,000 square feet of factory space. The persons that have posted using the present invention may have done so, not because they are particularly interested in selling their land, equipment or expertise, but rather they are there to put their goods and services in return for an equity portion of the joint venture, or deal, that the user is putting together. In our example, the user finds the posting of the 25,000 square foot factory space in Mobile, Ala., contacts the person and/or company that has posted the property on the website and negotiates a 25% equity interest in the joint venture in exchange for the right to locate the foundry operation there.

Now the user is in need of trucks and forklifts and looks for persons and/or companies that are offering this type of equipment. He again utilizes the present invention and looks for trucks or forklifts in the State of Alabama or any nearby states and he finds a gentleman in Louisiana that has three forklifts and two trucks. The user contacts the gentleman in Louisiana who agrees to contribute the trucks and forklifts for 10% of the equity in the project. The user now turns his attention to some badly needed expertise and begins to look for persons with mechanical engineering and/or chemistry backgrounds. He finds two retired persons who live near Mobile, Ala. that have these skills and negotiates a 5% equity stake for each who are willing to put in twenty hours a week.

At this point, the user has given up 45% equity in his project for the expertise and/or equipment and real estate. Now the user needs some special furnace equipment and finds a company in Tennessee that has the furnaces he wants. The company is not using the furnaces anymore and they are sitting idle. The user negotiates to give that company 20% of his venture in exchange for the furnaces. Finally, the user needs lab equipment and he discovers that a posting has been made on the website for lab equipment in New Jersey. The user calls the owner of the lab equipment in New Jersey and negotiates and agrees to swap 5% equity in the company for the lab equipment which will be shipped in from New Jersey.

The user has now negotiated to trade 70% of the equity stake in this joint venture, but he has everything that he needs and lacks only some working capital. There also may be people, or companies, that want to put up working capital as a posting that are looking for joint ventures, or deals, or the user may choose a traditional method of obtaining working capital. The user has now put the pieces of the pie together to build his foundry in Mobile, Ala.

This is just one small specific example of what and how the present invention can be used for linking business interests of any kind. It should be noted that all negotiations and all joint ventures, or deals, are worked out between the individual user or users and those that post utilizing the present invention.

It should be noted that either the user or the poster may be considered a customer 12 as it relates to the present invention in order to link the various business interests as desired. Thus, the present invention may link the user to the poster or the poster to the user in an active manner.

The present invention will be structured similarly like any other web site. Most web sites go from general to specific. The present invention will work in a similar manner.

For example, if the furnace desired in our foundry example is the piece of equipment that the user is looking for, he will first click on the category for equipment then will click further on the category for equipment offered in the Southeastern United States. The next more specific search would be for industrial equipment which would further be broken down into metal processing equipment which would be further divided into choppers, shredders, etc., smelters, furnaces, etc., to find the specific type of furnace that the user desires.

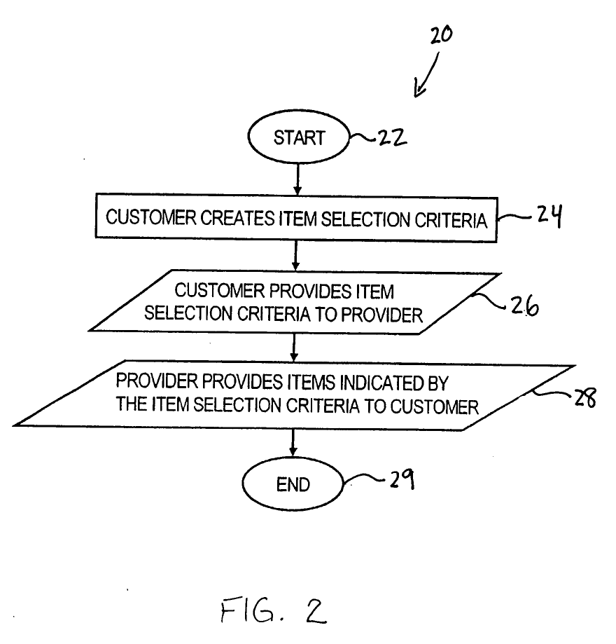

The approach just described for linking business interests to customers 12 is now described with reference to a flow diagram 20 of FIG. 2. After starting in step 22, in step 24, customer 12 creates item selection criteria. In step 26, customer 12 provides the item selection criteria to provider 14. In step 28, in response to provider 14 receiving the item selection criteria from customer 12, provider 14 provides one or more items indicated by the item selection criteria to customer 12. The process is complete in step 29.

The approach for linking business interests described herein is now described in the context of linking to customers business interests, such as equipment, real estate, purchase agreements, technical expertise, product purchasers, material inventories, intellectual property and investment capital.

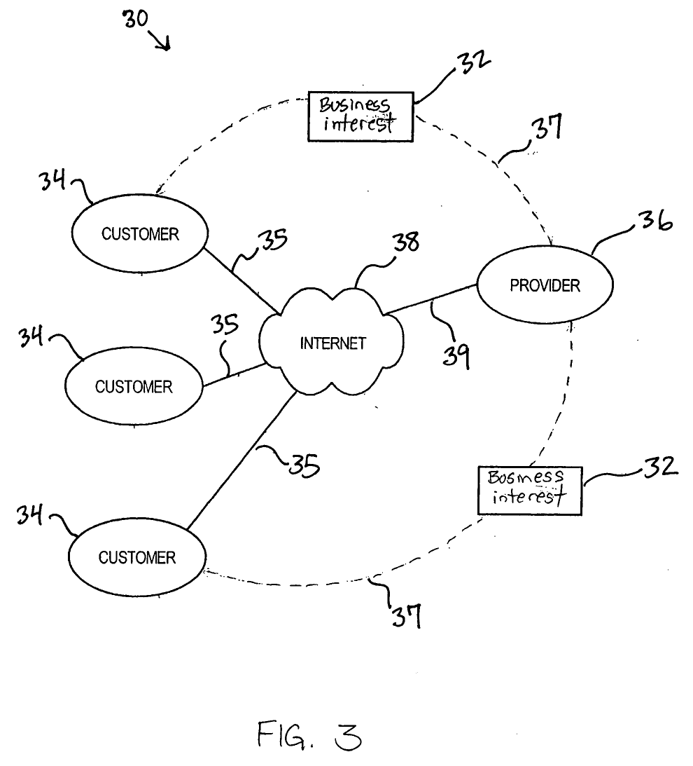

FIG. 3 is a diagram 30 that depicts a set of customers 34 that desire access to business interests 32 from a provider 36. Customers 34 communicate with provider 36 over links 35, the global packet-switched network referred to as the “Internet,” and a link 39.

Links 35 and 39 may be any medium for transferring data between customers 34 and the Internet 38 and between the Internet 38 and provider 36, respectively, and the invention is not limited to any particular medium. In the present example, links 35 and 39 may be connections provided by one or more Internet Service Providers (ISPs) and customers 34 are configured with generic Internet web browsers. Links 35 and 39 may be secure or unsecured depending upon the requirements of a particular application.

In accordance with an embodiment, customers 34 enter into a an agreement with provider 36 to be linked to business interests 32 from provider 36 accordingly. The invention is not limited to any particular approach for entering into the agreement. For example, customers 34 and provider 36 may enter into an agreement by mail, telephone or over the Internet, by customers 34 logging into a web site associated with provider 36. The business interests 32 are delivered to customers 34 over delivery channels 37 according to the terms of the agreement.

Customers 34 create and provide item selection criteria to provider 36 over links 35 and 39 and the Internet 38. The invention is not limited to any particular approach for specifying and providing item selection criteria to provider 36. For example, according to one embodiment, customers 34 provide item selection criteria to provider 36 in one or more data files. According to another embodiment, customers 34 log onto a web site of provider 36 and use a graphical user interfaced (GUI) to specify attributes of the business interests 32 that customers 34 desire to be linked from provider 36.

The item selection attributes may include any attributes that describe, at least in part, business interests 32 that customers 34 desires. For real estate, example attributes include, without limitation, land offerings, building availability, etc. For technical expertise, example attributes include, without limitation, laborers, engineers, chemists, etc. For intellectual property, example attributes include, without limitation, copyrights, patents and trademarks, etc. Customers 34 may identify specific business interests 32 by the item selection criteria, or may provide various attributes and allow provider 36 to automatically select particular business interests 32 that satisfy the attributes specified. For example, customers 34 may specify item selection criteria that include farm land in Kansas and let provider 36 automatically select farm land that was available in Kansas. As another example, customers 34 may specify item selection criteria that include types of farm equipment. Customers 34 may also specify types of farm equipment for the specified item selection criteria. For example, customers 34 may specify specific farm equipment and the priority order in which they want to receive it. As another example, customers 34 may specify that they want to receive a particular number of back hoes, etc. of different types.

The approach described herein for linking business interests 32 to customers 34 is applicable to any type of business application and (without limitation) is particularly well suited for Internet-based linking of business interests to customers. The invention may be implemented in hardware circuitry, in computer software, or a combination of hardware circuitry and computer software and is not limited to a particular hardware or software implementation.

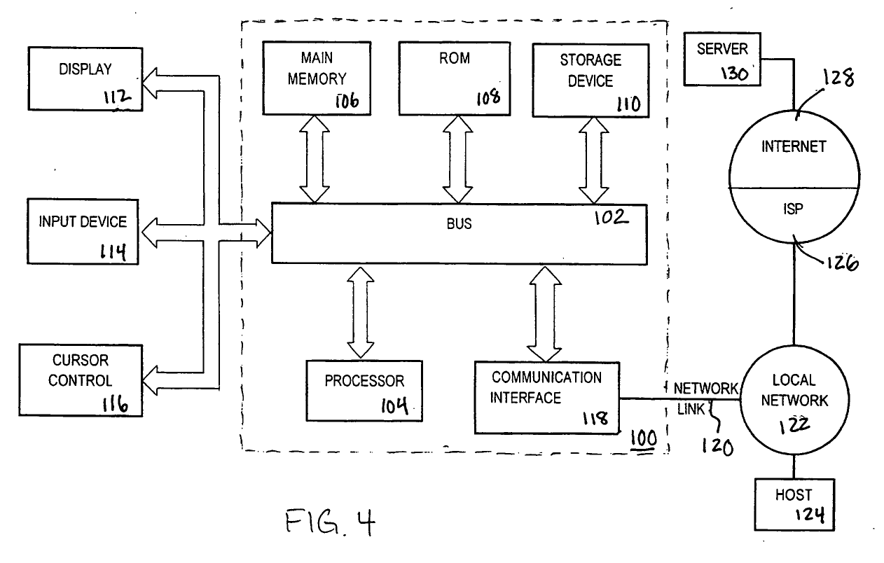

FIG. 4 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

The invention is related to the use of computer system 100 for linking business interest items to customers. According to one embodiment of the invention, the linking of business interests to customers is provided by computer system 100 in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. One or more processors in a multi-processing arrangement may also be employed to execute the sequences of instructions contained in main memory 106. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infrared transmitter to convert the data to an infrared signal. An infrared detector coupled to bus 102 can receive the data carried in the infrared signal and place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. In accordance with the invention, one such downloaded application provides for the linking of business interests to customers as described herein.

The received code may be executed by processor 104 as it is received, and/or stored in storage device 110, or other non-volatile storage for later execution. In this manner, computer system 100 may obtain application code in the form of a carrier wave.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A method for linking business interests, comprising the steps of:
receiving postings of business interests to a provider;
providing to a customer access to said postings; and
linking said customer to said business interests.

2. The method of claim 1, wherein said business interests consists of a group including, equipment, real estate, intellectual property, technical expertise, material inventories, purchase agreements, product purchases, and investment capital.

3. The method of claim 1, further comprising the step of the customer negotiating the linked business interests.

4. The method of claim 3, wherein the linking step consists of the customer creating item selection criteria.

5. The method of claim 4, further comprising the step of the customer providing item selection criteria to the provider.

6. The method of claim 5, further comprising the step of the provider providing items indicated by the item selection criteria to the customer.

7. The method of claim 6, wherein the provider utilized a computer system to implement the business links.

8. The method of claim 7, wherein the computer system uses the internet in the form of a web portal.

9. A computer-readable medium for linking business interests to customers, the computer-readable medium carrying one or more sequences of one or more instructions which, when executed by one or more processors, cause the one or more processors to perform the compute-implemented steps of:
receiving postings of business interests to a provider;
providing to a customer access to said postings; and
linking said customer to said business interests.

10. The computer-readable medium of claim 9, wherein said business interests consists of a group including, equipment, real estate, intellectual property, technical expertise, purchase agreements, material inventories, product purchases, and investment capital.

11. The computer-readable medium of claim 9, further comprising the step of the customer negotiating the linked business interests.

12. The computer-readable medium of claim 11, wherein the linking step consists of the customer creating item selection criteria.

13. The computer-readable medium of claim 12, further comprising the step of the customer providing item selection criteria to the provider.

14. The computer-readable medium of claim 13, further comprising the step of the provider providing items indicated by the item selection criteria to the customer.

15. An apparatus for linking business interests, comprising:
one or more processors; and
a memory communicatively coupled to the one or more processors, the memory including one or more sequences of one or more instructions which, when executed by the one or more processors, cause the one or more processors to perform the steps of:
receiving postings of business interests to a provider;
providing to a customer access to said postings; and
linking said customer to said business interests.

16. The apparatus of claim 15, wherein said business interests consists of a group including, equipment, real estate, intellectual property, technical expertise, purchase agreements, material inventories, product purchases, and investment capital.

17. The apparatus of claim 15, further comprising the step of the customer negotiating the linked business interests.

18. The apparatus of claim 17, wherein the linking step consists of the customer creating item selection criteria.

19. The apparatus of claim 18, further comprising the step of the customer providing item selection criteria to the provider.

20. The apparatus of claim 19, further comprising the step of the provider providing items indicated by the item selection criteria to the customer.
